(19) United States
(12) Patent Application Publication
(10) Pub. No.: US 2025/0384594 A1
(43) Pub. Date: Dec. 18, 2025

(54) CONTENT ALIGNMENT AND TRANSFER TO DEVICE CAMERA FEED

(71) Applicant: Lenovo (Singapore) Pte.Ltd., Singapore (SG)

(72) Inventors: Mengnan Wang, Durham, NC (US); Song Wang, Cary, NC (US); Yuan Yu, Morrisville, NC (US)

(21) Appl. No.: 18/743,390

(22) Filed: Jun. 14, 2024

(51) Int. Cl. G06T 11/00; G01B 11/22; G01S 7/4865; G01S 17/86; G01S 17/894; G06F 3/14

(52) U.S. Cl. CPC G06T 11/00; G01B 11/22; G01S 7/4865; G01S 17/86; G01S 17/894; G06F 3/14

(57) ABSTRACT

A computer implemented method includes receiving a first depth map of a spatial computing device field of view and receiving a second depth map of a mobile device camera field of view. The first and second depth maps are aligned. A spatial computing device field of view location of spatial computing device generated content displayed by the spatial computing device is then determined. The spatial computing device generated content and spatial computing device field of view location are sent to the mobile device for use in displaying the content by the mobile device in a manner that is aligned with the content displayed int eh spatial computing device.

### BACKGROUND

Mixed reality (MR) headsets or other spatial computing devices can display content that a wearer can see via the headset display. The content may be displayed in a fully virtual environment where the user can only see what is displayed. The content may alternatively be overlayed with reality in a mixed reality environment where content is displayed while allowing users to see reality.

One difficulty associated with MR headsets is that a wearer may also desire to utilize another device at the same time while wearing the MR headset. Since the content is only overlayed on the MR headset display, other devices, such as a smartphone cannot directly capture all that the wearer is seeing and do not allow separate user interaction with the content.

### SUMMARY

A computer implemented method includes receiving a first depth map of a spatial computing device field of view and receiving a second depth map of a mobile device camera field of view. The first and second depth maps are aligned. A spatial computing device field of view location of spatial computing device generated content displayed by the spatial computing device is then determined. The spatial computing device generated content and spatial computing device field of view location are sent to the mobile device for use in displaying the content by the mobile device in a manner that is aligned with the content displayed int eh spatial computing device

### BRIEF DESCRIPTION OF THE DRAWINGS

FIG. 1 is a block diagram of a system 100 that includes an MR headset that captures an image or images of an environment in which the MR headset 110 is located according to an example embodiment.

FIG. 2 is a block diagram illustrating components utilized in synchronizing views of the MR headset and mobile device for properly placing the overlay content in mobile device view according to an example embodiment.

FIG. 3 is an image illustrating an MR headset view of physical reality that includes an MR headset generated QR code according to an example embodiment.

FIG. 4 is a flowchart illustrating a computer implemented method of displaying MR headset generated content on a mobile device for interaction with by the mobile device according to an example embodiment.

FIG. 5 is a block schematic diagram of a computer system to implement one or more example embodiments.

### DETAILED DESCRIPTION

In the following description, reference is made to the accompanying drawings that form a part hereof, and in which is shown by way of illustration specific embodiments which may be practiced. These embodiments are described in sufficient detail to enable those skilled in the art to practice the invention, and it is to be understood that other embodiments may be utilized and that structural, logical and electrical changes may be made without departing from the scope of the present invention. The following description of example embodiments is, therefore, not to be taken in a limited sense, and the scope of the present invention is defined by the appended claims.

Current spatial computing device applications such as mixed reality (MR) headset applications often present overlay content that cannot be directly captured or interacted with by a mobile device, hindering seamless user interaction. Without using spatial computing devices, for instance, the user is using a TV and wants to take a video or picture of the content on the TV, this has not been an issue. In spatial computing devices, the content being displayed only exists in the MR space. This limitation affects various tasks beyond QR code scanning, impeding the ability to view, interact with, or share content displayed in the MR space with other devices.

Existing solutions for interacting with overlay content in spatial computing devices primarily rely on the headset itself, limiting the ability to share or synchronize content with external mobile devices such as smartphones, tablets, laptops, or other devices allowing users to interact with displayed content. Users are thus unable to seamlessly integrate MR experiences with their smartphones for tasks such as content sharing or collaborative interactions.

An improved system enables the transfer of overlay content displayed in an MR space by an spatial computing device to a mobile device's camera output, referred to as a feed, allowing the mobile device to interact with the overlay content. The system ensures accurate real-time display synchronization between the MR headset and mobile device.

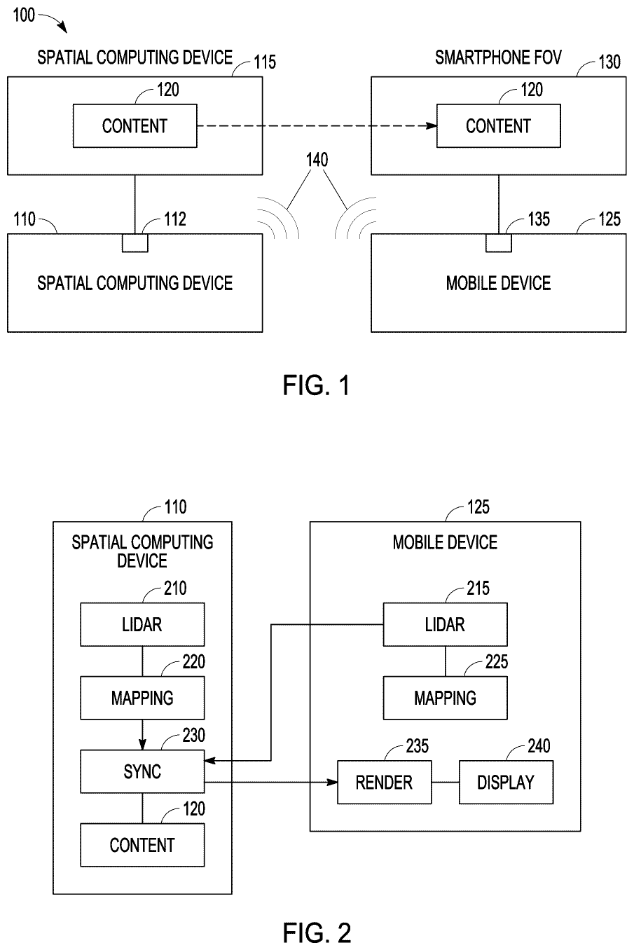

FIG. 1 is a block diagram of a system 100 that includes a spatial computing device 110, such as an MR headset, that captures an image or images of an environment in which the spatial computing device 110 is located. The images from one or more spatial computing device cameras 112 are stitched into an spatial computing device space 115, which may include a 360-degree view of the environment around the spatial computing device 110. Content 120 may be projected onto a view of the space 115 where a user/wearer of the headset is looking.

System 100 may also include a mobile device 125 being used by the user. The user may desire to interact with the content 120 via the mobile device 125. Mobile device 125 include any type of electronic device that can capture images 130 via a camera 135 and allow a user to interact with the images. In one example, a communication link 140 may be established between the spatial computing device 110 and the mobile device 125 to enable data transfer between them. For example, content 120 may be transferred as overlay content 120 and rendered for display in a mobile device display along with an image feed or output of the camera 135. The overlay content 120 may also be stored by the mobile device along with an image feed from the camera 135.

The wireless communication link 140 may be a WiFi or Bluetooth connection, between the spatial computing device 110 and the mobile device 125. When a user aims the mobile device camera 135 towards a field of view as shown in mobile device display that includes the spatial computing device's displayed content 120, the system 100 detects the camera's direction by comparing fields of view through information acquired via communication link 140. Subsequently, the content 120 displayed as an overlay in the spatial computing device space 115 is transmitted in real-time to the mobile device's camera 135 feed and shows up in a mobile device display, such as a view finder and is captured via video or photo modes of the mobile device 125.

In addition to content transfer, the system synchronizes the spatial relationship of the headset's overlaid content with images captured by the mobile device camera 135. Such synchronization ensures that the overlay content 120 appears in the correct position and perspective relative to the mobile device's camera view. By continuously updating the positional and orientational data of the spatial computing device space 115 and the mobile device camera 135 field of view, the system dynamically adjusts the displayed overlay content 120 in the mobile device display to maintain its spatial alignment with the camera's perspective.

The synchronization ensures that when the mobile device camera 135 moves, the overlay content 120 stays in the relative location within the mobile device's camera view on display, creating a seamless augmented reality experience that can be captured and interacted with by the mobile device 125. Users can perceive the MR overlay content 120 through their mobile device 125 as if the MR overlay content were directly integrated into the users physical environment, enhancing immersion and usability across different viewing angles and distances via multiple devices.

This synchronization of spatial relationship enables users to interact with MR overlay content more intuitively, as the overlay remains consistent with the surrounding physical environment regardless of the mobile device camera 135 movement. Whether users are exploring virtual objects or navigating augmented environments, the system 100 ensures that the overlaid content 120 maintains its spatial coherence with the real-world perspective captured by the mobile device camera 135.

FIG. 2 is a block diagram illustrating components utilized in synchronizing views of the spatial computing device 110 and mobile device 125 for properly placing the overlay content 120 in mobile device 125 view. In one example, the system 100 functions may be integrated with the spatial computing device 110 circuitry, the mobile device 125 circuitry, or remote computing resources, such as cloud-based resources. Both the spatial computing device 110 and mobile device 125 include respective light detection and ranging (LIDAR) sensors 210 and 215 configured to generate respective 3D depth mappings 220 and 225 of their fields of view, also referred to as their “space.”

The LIDAR sensors 210 and 215 create the depth mappings 220 and 225 by measuring the time it takes (referred to as time of flight (TOF)) for laser pulses to reflect off objects and return to the sensor given a known speed of light. The depth mappings 220 and 225 may be serialized and embedded inside an image container as described by an Adobe XMP standard. A depth map is defined as an image of values (integer or real) that represent distance from the view point.

The spatial computing device 110 in one example generates the depth mapping 220 of the full space around the spatial computing device 110, while the mobile device 125 depth mapping 225 is defined by a field of view captured by the camera 135 which is likely much less than the full space. The LIDAR sensors 210 and 215 record the data as a 3D point relative to its own position.

Each depth mapping 220 and 225 divides the respective fields of view into pixels that include a location within the field of view and a depth from the LIDAR sensors 210 and 215. In one example, the location and depth are stored as the mappings 220 and 225 with a fidelity expressed as an array such as 640×480 pixels. The depth may be represented monochromatically, essentially producing an image which may be stored in PNG format.

Other fidelities and formats may be used provided they enable a comparison of the mappings to identify corresponding locations within the maps to synchronize the position of the overlay content 120 from the spatial computing device 110. Lower fidelity or resolution maps contain less data to transfer resulting in higher speed transfers but also provide less accuracy in placing the content 120. For applications that do not require accuracy, such as content that includes a QR code for interaction with by the mobile device, lower fidelity maps may be used. In one example, the QR code may simply be placed centered or any other desired location in the mobile device camera feed for interaction with via the mobile device 125.

Data compression of maps may also be used to further enhance data transfer speeds. In still further examples, depth sampling may be performed by the spatial computing device 110v in the area corresponding to the position of the overlay content 120 and then compared to the mobile device generated mapping 225 to identify corresponding areas and place the overlay content 120 in the correct location of the camera feed for processing and display via the mobile device display.

Various algorithms may be used for synchronizing depth maps via a synchronizing unit 230. While synchronizing unit 230 is shown in the spatial computing device 110, it may alternatively be located in the mobile device 125. In further examples, the synchronizing unit 230 functions may be distributed between the spatial computing device 110, mobile device 125, or even remote computing resources such as cloud based computing resources. The appropriate algorithm implemented by the synchronizing unit 230 may be selected based on processing resources available and desired response times.

Iterative Closest Point (ICP) algorithms may be used to synchronize depth maps. ICP iteratively aligns two point clouds by minimizing the distance between corresponding points. Variants like Point-to-Point ICP, Point-to-Plane ICP, or Robust ICP can be used depending on the specific characteristics of the depth maps.

Features like keypoints (e.g., corners, edges) extracted from depth maps can be matched between the two maps. Common techniques include SIFT (Scale-Invariant Feature Transform) or SURF (Speeded Up Robust Features). Once correspondences are established, techniques such as RANSAC (Random Sample Consensus) can be used to robustly estimate the transformation between the two depth maps.

Depth maps may be represented as graphs where nodes are points or regions and edges represent spatial relationships. Techniques like graph matching or graph alignment may be used to synchronize the graphs. Some methods include Graph Edit Distance or Graph Neural Networks.

Optical flow algorithms estimate the motion of objects between consecutive frames. Depth maps can be treated as consecutive frames, and optical flow techniques can be used to estimate the transformation between them. Optical flow may aid where there is significant movement in one or both of the mobile device camera and spatial computing device camera or cameras.

Deep learning techniques, particularly convolutional neural networks (CNNs), can be used for depth map synchronization. Siamese networks or triplet networks can learn embeddings of depth maps and then use similarity metrics to synchronize them. Generative adversarial networks (GANs) or autoencoders can also be used for depth map alignment tasks. Deep learning techniques may require significant processing resources and are less likely to be used given current processing and heat generation limitations for spatial computing devices.

Global registration techniques aim to find a transformation that aligns the entire depth maps rather than just corresponding points or features. Methods like Normal Distributions Transform (NDT) or Coherent Point Drift (CPD) can be used for global registration.

The choice of algorithm depends on various factors such as the nature of the depth maps, computational resources, required accuracy, and specific application requirements. Often, a combination of these techniques might be used for better synchronization results.

In some examples, multiple selected portions of the spatial computing device map may be selected for synchronization with the mobile device map. Such portions may be selected based on a statistical analysis of depths to find portions that have a higher measure of change, such as a higher standard deviation. Use of such portions can reduce the processing time needed to find matching portions and then properly register the overlay content based on synchronized portions.

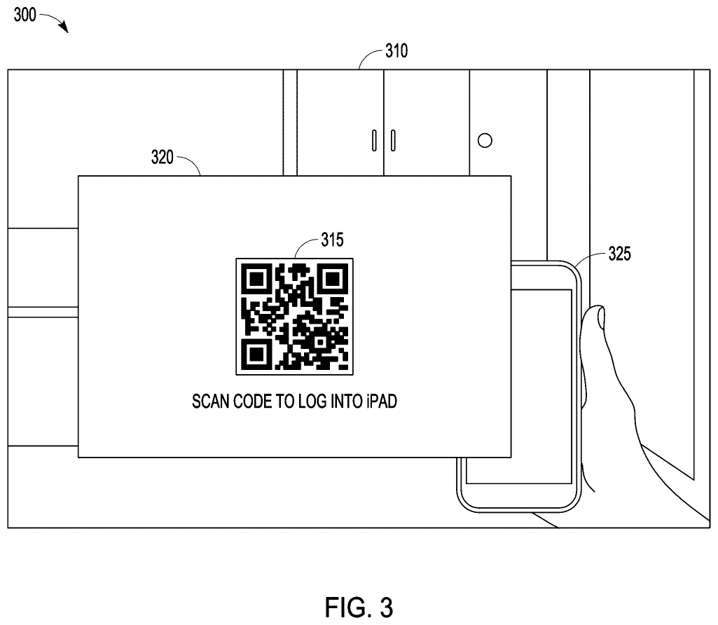

FIG. 3 is an image 300 illustrating an spatial computing device view 310 of physical reality that includes an spatial computing device generated QR code 315 within a window 320. A mobile device 325 is shown generally aimed towards an area corresponding to the position of the QR code 315 within the spatial computing device view 310. A view on a display of the mobile device will include the QR code 315 in a position corresponding to the position of the QR code in the spatial computing device view 310, allowing the user of the mobile device to directly interact with the QR code.

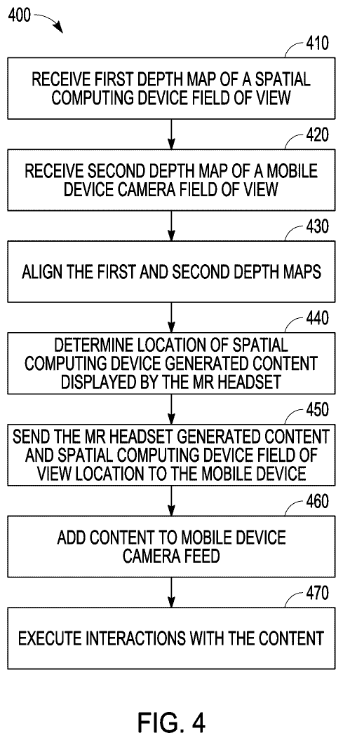

FIG. 4 is a flowchart illustrating a computer implemented method 400 of displaying spatial computing device generated content on a mobile device for interaction with by the mobile device. Method 400 begins at operation 410 by receiving a first depth map of a mixed reality (MR) headset field of view. A

second depth map of a mobile device camera field of view is received at operation 420. Operation 430 aligns the first and second depth maps. An spatial computing device field of view location of spatial computing device generated content displayed by the spatial computing device is determined at operation 440. The spatial computing device generated content and spatial computing device field of view location is sent at operation 450 to the mobile device.

Operation 460 adds the spatial computing device generated content as an overlay to a mobile device camera feed such that the spatial computing device generated content appears in the camera feed at a synchronized location. Operation 470 executes interactions with the MR generated content via the mobile device, such as a user selection of a QR code to obtain characters or a hyperlink that is automatically used to navigate to a web page.

The first depth map is generated by a LIDAR sensor of the spatial computing device and the second depth map is generated by a LIDAR sensor of the mobile device.

Different methods or combination of methods may be used to align the first and second depth maps, such as using an iterative closest point algorithm, selecting multiple portions of the first depth map and searching for corresponding portions of the second depth map, or synchronizing the first and second depth maps by selecting an area around the spatial computing device generated content and searching for a corresponding area of the second depth map.

The first and second depth maps may have resolutions of 640×480 pixels. In further examples, the resolutions may be variable to adjust processing resources required to perform aligning of the first and second maps.

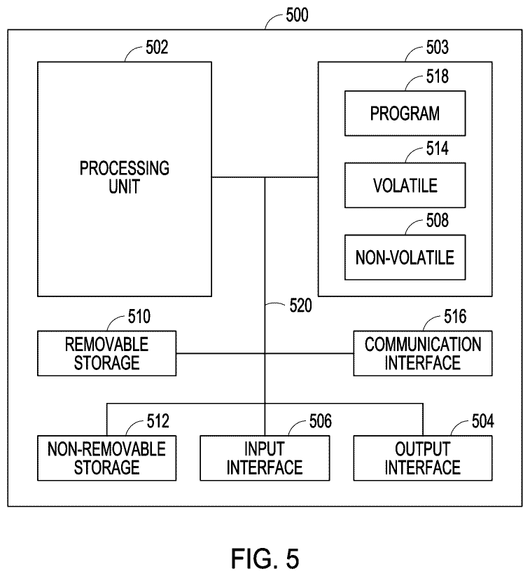

FIG. 5 is a block schematic diagram of a computer system 500 to implement HR headsets and mobile devices, and even remote computing resources for performing the described functions of synchronizing depth maps/mappings, determining positions of content, and for performing methods and algorithms according to example embodiments. All components need not be used in various embodiments.

One example computing device in the form of a computer 500 may include a processing unit 502, memory 503, removable storage 510, and non-removable storage 512. Although the example computing device is illustrated and described as computer 500, the computing device may be in different forms in different embodiments. For example, the computing device may instead be a mobile device, a tablet, smartwatch, smart storage device (SSD), or other computing device including the same or similar elements as illustrated and described with regard to FIG. 5. Devices, such as mobile devices, tablets, and smartwatches, are generally collectively referred to as mobile devices or user equipment.

Although the various data storage elements are illustrated as part of the computer 500, the storage may also or alternatively include cloud-based storage accessible via a network, such as the Internet or server-based storage. Note also that an SSD may include a processor on which the parser may be run, allowing transfer of parsed, filtered data through I/O channels between the SSD and main memory.

Memory 503 may include volatile memory 514 and non-volatile memory 508. Computer 500 may include—or have access to a computing environment that includes—a variety of computer-readable media, such as volatile memory 514 and non-volatile memory 508, removable storage 510 and non-removable storage 512. Computer storage includes random access memory (RAM), read only memory (ROM), erasable programmable read-only memory (EPROM) or electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices, or any other medium capable of storing computer-readable instructions.

Computer 500 may include or have access to a computing environment that includes input interface 506, output interface 504, and a communication interface 516. Output interface 504 may include a display device, such as a touchscreen, that also may serve as an input device. The input interface 506 may include one or more of a touchscreen, touchpad, mouse, keyboard, camera, one or more device-specific buttons, one or more sensors integrated within or coupled via wired or wireless data connections to the computer 500, and other input devices. The computer may operate in a networked environment using a communication connection to connect to one or more remote computers, such as database servers. The remote computer may include a personal computer (PC), server, router, network PC, a peer device or other common data flow network switch, or the like. The communication connection may include a Local Area Network (LAN), a Wide Area Network (WAN), cellular, Wi-Fi, Bluetooth, or other networks. According to one embodiment, the various components of computer 500 are connected with a system bus 520.

Computer-readable instructions stored on a computer-readable medium are executable by the processing unit 502 of the computer 500, such as a program 518. The program 518 in some embodiments comprises software to implement one or more methods described herein. A hard drive, CD-ROM, and RAM are some examples of articles including a non-transitory computer-readable medium such as a storage device. The terms computer-readable medium, machine readable medium, machine readable storage device, and storage device do not include carrier waves or signals to the extent carrier waves and signals are deemed too transitory. Storage can also include networked storage, such as a storage area network (SAN). Computer program 518 along with the workspace manager 522 may be used to cause processing unit 502 to perform one or more methods or algorithms described herein.

### EXAMPLES

1. A computer implemented method includes receiving a first depth map of a spatial computing device field of view and receiving a second depth map of a mobile device camera field of view. The first and second depth maps are aligned. A spatial computing device field of view location of spatial computing device generated content displayed by the spatial computing device is then determined. The spatial computing device generated content and spatial computing device field of view location are sent to the mobile device for use in displaying the content by the mobile device in a manner that is aligned with the content displayed int eh spatial computing device.

2. The method of example 1 and further including adding the spatial computing device generated content as an overlay to a mobile device camera feed such that the spatial computing device generated content appears in the camera feed at a synchronized location.

3. The method of example 2 and further including executing interactions with the MR generated content via the mobile device.

4. The method of example 3 wherein the MR generated content includes a QR code.

5. The method of any of examples 1-4 wherein the first depth map is generated by a LIDAR sensor of the spatial computing device and the second depth map is generated by a LIDAR sensor of the mobile device.

6. The method of any of examples 1-5 wherein aligning the first and second depth maps includes synchronizing the first and second depth maps using an iterative closest point algorithm.

7. The method of any of examples 1-6 wherein aligning the first and second depth maps includes synchronizing the first and second depth maps by selecting multiple portions of the first depth map and searching for corresponding portions of the second depth map.

8. The method of any of examples 1-7 wherein aligning the first and second depth maps comprises synchronizing the first and second depth maps by selecting an area around the spatial computing device generated content and searching for a corresponding area of the second depth map.

9. The method of any of examples 1-8 wherein first and second depth maps have resolutions of 640×480 pixels.

10. The method of any of examples 1-9 wherein the first and second depth maps have resolutions that are variable to adjust processing resources required to perform aligning of the first and second maps.

11. A machine-readable storage device has instructions for execution by a processor of a machine to cause the processor to perform operations to perform any of the methods of examples 1-11.

12. A device includes a processor and a memory device coupled to the processor and having a program stored thereon for execution by the processor to perform operations to perform any of the methods of examples 1-11.

The functions or algorithms described herein may be implemented in software in one embodiment. The software may consist of computer executable instructions stored on computer readable media or computer readable storage device such as one or more non-transitory memories or other type of hardware-based storage devices, either local or networked. Further, such functions correspond to modules, which may be software, hardware, firmware or any combination thereof. Multiple functions may be performed in one or more modules as desired, and the embodiments described are merely examples. The software may be executed on a digital signal processor, ASIC, microprocessor, or other type of processor operating on a computer system, such as a personal computer, server or other computer system, turning such computer system into a specifically programmed machine.

The functionality can be configured to perform an operation using, for instance, software, hardware, firmware, or the like. For example, the phrase “configured to” can refer to a logic circuit structure of a hardware element that is to implement the associated functionality. The phrase “configured to” can also refer to a logic circuit structure of a hardware element that is to implement the coding design of associated functionality of firmware or software. The term “module” refers to a structural element that can be implemented using any suitable hardware (e.g., a processor, among others), software (e.g., an application, among others), firmware, or any combination of hardware, software, and firmware. The term, “logic” encompasses any functionality for performing a task. For instance, each operation illustrated in the flowcharts corresponds to logic for performing that operation. An operation can be performed using, software, hardware, firmware, or the like. The terms, “component,” “system,” and the like may refer to computer-related entities, hardware, and software in execution, firmware, or combination thereof. A component may be a process running on a processor, an object, an executable, a program, a function, a subroutine, a computer, or a combination of software and hardware. The term, “processor,” may refer to a hardware component, such as a processing unit of a computer system.

Furthermore, the claimed subject matter may be implemented as a method, apparatus, or article of manufacture using standard programming and engineering techniques to produce software, firmware, hardware, or any combination thereof to control a computing device to implement the disclosed subject matter. The term, “article of manufacture,” as used herein is intended to encompass a computer program accessible from any computer-readable storage device or media. Computer-readable storage media can include, but are not limited to, magnetic storage devices, e.g., hard disk, floppy disk, magnetic strips, optical disk, compact disk (CD), digital versatile disk (DVD), smart cards, flash memory devices, among others. In contrast, computer-readable media, i.e., not storage media, may additionally include communication media such as transmission media for wireless signals and the like.

Although a few embodiments have been described in detail above, other modifications are possible. For example, the logic flows depicted in the figures do not require the particular order shown, or sequential order, to achieve desirable results. Other steps may be provided, or steps may be eliminated, from the described flows, and other components may be added to, or removed from, the described systems. Other embodiments may be within the scope of the following claims.

1. A computer implemented method comprising:
receiving a first depth map of a mixed reality (MR) headset field of view;
receiving a second depth map of a mobile device camera field of view;
aligning the first and second depth maps;
determining a spatial computing device field of view location of spatial computing device generated content displayed by the spatial computing device; and
sending the spatial computing device generated content and spatial computing device field of view location to the mobile device.

2. The method of claim 1 and further comprising adding the spatial computing device generated content as an overlay to a mobile device camera feed such that the spatial computing device generated content appears in the camera feed at a synchronized location.

3. The method of claim 2 and further comprising executing interactions with the MR generated content via the mobile device.

4. The method of claim 3 wherein the MR generated content comprises a QR code.

5. The method of claim 1 wherein the first depth map is generated by a LIDAR sensor of the spatial computing device and the second depth map is generated by a LIDAR sensor of the mobile device.

6. The method of claim 1 wherein aligning the first and second depth maps comprises synchronizing the first and second depth maps using an iterative closest point algorithm.

7. The method of claim 1 wherein aligning the first and second depth maps comprises synchronizing the first and second depth maps by selecting multiple portions of the first depth map and searching for corresponding portions of the second depth map.

8. The method of claim 1 wherein aligning the first and second depth maps comprises synchronizing the first and second depth maps by selecting an area around the spatial computing device generated content and searching for a corresponding area of the second depth map.

9. The method of claim 1 wherein first and second depth maps have resolutions of 640×480 pixels.

10. The method of claim 1 wherein the first and second depth maps have resolutions that are variable to adjust processing resources required to perform aligning of the first and second maps.

11. A machine-readable storage device having instructions for execution by a processor of a machine to cause the processor to perform operations to perform a method, the operations comprising:
receiving a first depth map of a mixed reality (MR) headset field of view;
receiving a second depth map of a mobile device camera field of view;
aligning the first and second depth maps;
determining a spatial computing device field of view location of spatial computing device generated content displayed by the spatial computing device; and
sending the spatial computing device generated content and spatial computing device field of view location to the mobile device.

12. The device of claim 11 wherein the operations further comprise adding the spatial computing device generated content as an overlay to a mobile device camera feed such that the spatial computing device generated content appears in the camera feed at a synchronized location.

13. The device of claim 12 wherein the operations further comprise executing interactions with the MR generated content via the mobile device.

14. The device of claim 13 wherein the MR generated content comprises a QR code.

15. The device of claim 11 wherein the first depth map is generated by a LIDAR sensor of the spatial computing device and the second depth map is generated by a LIDAR sensor of the mobile device.

16. The device of claim 11 wherein aligning the first and second depth maps comprises synchronizing the first and second depth maps using an iterative closest point algorithm.

17. The device of claim 11 wherein aligning the first and second depth maps comprises synchronizing the first and second depth maps by selecting multiple portions of the first depth map and searching for corresponding portions of the second depth map.

18. The device of claim 11 wherein aligning the first and second depth maps comprises synchronizing the first and second depth maps by selecting an area around the spatial computing device generated content and searching for a corresponding area of the second depth map.

19. A device comprising:
a processor; and
a memory device coupled to the processor and having a program stored thereon for execution by the processor to perform operations comprising.
receiving a first depth map of a mixed reality (MR) headset field of view;
receiving a second depth map of a mobile device camera field of view;
aligning the first and second depth maps;
determining a spatial computing device field of view location of spatial computing device generated content displayed by the spatial computing device; and
sending the spatial computing device generated content and spatial computing device field of view location to the mobile device.

20. The device of claim 19 wherein the operations further comprise adding the spatial computing device generated content as an overlay to a mobile device camera feed such that the spatial computing device generated content appears in the camera feed at a synchronized location.
